(19) United States
(12) Patent Application Publication
(10) Pub. No.: US 2006/0035101 A1
(43) Pub. Date: Feb. 16, 2006

(54) Multinary bulk and thin film alloys and methods of making

(76) Inventors: Jikang Yuan, Storrs, CT (US); Steven Lawrence Suib, Storrs, CT (US)

Correspondence Address: CANTOR COLBURN, LLP, 55 GRIFFIN ROAD SOUTH, BLOOMFIELD, CT, 06002, US

(21) Appl. No.: 11/204,228

(22) Filed: Aug. 15, 2005

Related U.S. Application Data
(60) Provisional application No. 60/601,792, filed on Aug. 16, 2004.

(51) Int. Cl. B05D 1/18; B22D 7/00; B32B 15/00

(52) U.S. Cl. 428/615; 427/430.1; 427/437; 427/443.1; 428/544

(57) ABSTRACT

Processes for making multinary bulk and thin film alloys with nanometer-scale grains are disclosed. An electroless process includes contacting a substrate with a bath within a sealed pressure vessel; and heating the sealed pressure vessel for a time and at a temperature under an autogeneous pressure effective for plating a film of an alloy with nanometer-scale grains onto a contacted portion of the substrate; wherein the bath is formed from one or more salts comprising each constituent element of the alloy, an organic medium, and a reducing agent. The bulk and thin film alloys may be useful in applications requiring high surface area materials or protection from corrosion such as for catalysts and battery cathodes.

### CROSS REFERENCE TO RELATED APPLICATIONS

The present application relates to, and claims the benefit of, U.S. Provisional Patent Application No. 60/601,792, which was filed on Aug. 16, 2004 and is incorporated herein in its entirety.

### BACKGROUND

Plating of alloys is a well-known process used to alter the existing surface properties or dimensions of a substrate. The two most commonly utilized methods of plating include electroplating and electroless plating. Electroplating involves the formation of an electrolytic cell wherein a plating metal acts as an anode, a substrate acts as a cathode, and an external electrical charge supplied to the cell facilitates the coating of the substrate. In contrast, electroless plating involves deposition of a coating from a bath onto a substrate by a controlled chemical reduction that is autocatalytic. Electroless plating is favored over electroplating in part because no external electrical charge is required, irregularly shaped substrates can be plated with uniform deposit thickness, and the virtually nonporous deposits provide superior corrosion resistance.

Electroless plating baths often comprise water, water soluble compounds containing the metals to be alloyed, a complexing agent that prevents chemical reduction of the metal ions in solution while permitting selective chemical reduction on a surface of the substrate, and a chemical reducing agent for the metal ions. The bath may further comprise a buffer for controlling pH and various optional additives, such as bath stabilizers and surfactants. Thus, a drawback of electroless plating processes is their complexity. The baths are inherently unstable, and are thus prone to numerous unwanted side reactions that result in sludge formation and plate-out of metals. A wide variety of additives have been developed in an attempt to prevent and/or control these reactions. Despite the numerous components comprising the bath, elimination of plate-out and sludge remains difficult. Consequently, bath replacement, bath regeneration, and waste segregation/treatment steps limit the efficiency of electroless plating processes.

There accordingly remains a need in the art for new methods for electroless plating of alloy thin films. It would be particularly advantageous if such methods could eliminate or result in decreased plate-out and sludge formation. It would further be advantageous if such methods minimize waste segregation or treatment steps.

### SUMMARY

In one embodiment, an electroless plating process comprises contacting a substrate with a bath within a sealed pressure vessel and heating the sealed pressure vessel for a time and at a temperature under an autogeneous pressure effective to plate a film of an alloy comprising nanometer-scale grains onto the substrate, wherein the bath is formed from one or more salts comprising each constituent element of the alloy, an organic medium, and a reducing agent.

In another embodiment, an electroless process for the formation of a bulk alloy comprises heating a bath in a sealed pressure vessel for a time and at a temperature under an autogeneous pressure effective to form a bulk alloy with nanometer-scale grains, wherein the bath is formed from one or more salts comprising each constituent element of the alloy, an organic medium, and a reducing agent.

Other embodiments comprise articles made by the above processes.

Other embodiments comprise compositions made by the above processes.

Still other embodiments comprise articles made from the above compositions.

### BRIEF DESCRIPTION OF THE DRAWINGS

Referring now to the Figures, which are exemplary embodiments, and wherein the like elements are numbered alike:

FIG. 1 is a powder X-ray diffraction pattern of a Sn—Sb alloy thin film; and

FIG. 2 is a scanning electron micrograph of a Sn—Sb alloy thin film.

### DETAILED DESCRIPTION

Disclosed herein is an electroless process for plating alloys with nanometer-scale grains (i.e., about 1 to about 1000 nanometers) onto substrates within sealed pressure vessels. Also disclosed is a process for producing bulk alloys with nanometer-scale grains within sealed pressure vessels. In contrast to the processes of the prior art, the present processes minimize waste treatment costs and steps because any sludge within the bath may simply be filtered out and the bath may be reused. The electroless plating process effectively eliminates plate-out of metals on vessel walls and minimizes sludge formation. Additionally, the process is continuous and may be maintained for virtually an infinite time by merely replenishing each of the components of the bath.

The term “electroless” has its ordinary meaning as used herein, and generically describes deposition of a coating by a controlled chemical reduction that is autocatalytic. As used herein, the term “alloy” generally describes a solid solution comprising greater than or equal to two constituent elements, as opposed to a mixture containing phases of the constituent elements. The term “substrate” is used herein for convenience, and includes materials having irregular shapes such as flakes as well as regular shapes such as for example spheres, sheets, and films. The term “pressure vessel” as used herein generally describes an airtight vessel of any size that permits application of pressure, and further permits control of temperature and agitation of its contents. The term “bath” has its ordinary meaning as used herein and includes a solution, exclusive of the vessel, in which the alloy is formed. It is to be understood that “solution” as used herein refers to liquids in which the bath components have been fully or partially dissolved.

Also as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges reciting the same physical property are inclusive of the recited endpoints and independently combinable.

Electroless baths suitable for the formation of multinary alloys having nanoscale grains are solutions formed from one or more salts comprising each constituent element of the alloy and a reducing agent in an organic medium. Other additives known in the art may also be used.

The baths are formed from one or more salts that provide the constituent elements of the alloy. As used herein, “salts” is inclusive of any species that can provide the constituent element in an electroless process. Such salts generally comprise a cation and an anion. The salt may be complex, i.e., formed from one or more cations and/or anions. The constituent element is generally present as a cation in any of its oxidation states. Suitable constituent elements therefore include the cations of metals such as Sn, Sb, Pt, Rh, Bi, Hg, Pb, Cu, Ag, Au, In, Cd, Zn, Si, Ge, As, Pd, Co, and Ni. In one embodiment, the cation is a cation of Sn, Sb, Pb and Hg.

The anion is selected so as to allow the cation to react in the electroless process to form the alloy. For example, the anion is such that it may dissociate from the cation and provide a free cation, coordination complex, or other reactive species to the bath. Examples of suitable anions include halides, such as fluoride, chloride, bromide, and iodide; chalcogenides such as sulfide, selenide, and telluride; oxides; nitrides; pnictides such as phosphide, and antimonide; nitrates; nitrites; sulfates; sulfites; acetates; and carbonates. In an exemplary embodiment, the anions are chlorides.

A single salt may be used to provide more than one constituent element. In another embodiment, more than one salt, i.e., a mixture of salts, may be used to provide the same constituent element. The amount of each salt present in the bath is about 10 to about 35 grams per liter of bath (g/L). Specifically, the amount of each salt present in the bath is about 15 to about 30 g/L and more specifically about 18 to about 25 g/L.

The reducing agent in the bath reacts with the cation, coordination complex, or other reactive species to reduce the constituent metal to its elemental oxidation state. Examples of suitable reducing agents include alkali metal borohydrides, hydrazine, and boranes such as dimethylaminoborane. In an exemplary embodiment, the reducing agent is potassium borohydride (KBH₄). The amount of reducing agent present in the bath is about 10 to about 50 g/L. Specifically, the amount of reducing agent present in the bath is about 12 to about 40 g/L, and more specifically about 15 to about 35 g/L.

The baths are formed in a non-aqueous medium, i.e., an organic medium. Desirably, the organic medium acts as both a solvent and a chelating or complexing agent. Without being bound by theory, it is believed that the organic medium chelates to, or coordinates with, the free cation and, along with a dissociated anion of the constituent element salt, forms a coordination complex. Formation of the coordination complex is believed to prevent plate-out and sludge formation. The organic medium is selected such that it will not decompose during the heating of the sealed pressure vessel. Suitable organic media include, for example, amines such as primary, secondary, tertiary, and quaternary amines; diamines such as ethylenediamine, ethylenediaminetetraacetic acid (EDTA), and the like; and porphyrins such as porphine and heme, and the like. In an exemplary embodiment, the organic medium is ethylenediamine. The amount of organic medium present in the bath is about 500 to about 800 g/L. Specifically, the amount of organic medium present in the bath is about 550 to about 720 g/L, and more specifically about 600 to about 700 g/L.

In one embodiment, the bath may further contain other components known in the art. Preferably, however, the bath contains essentially no substances capable of accumulating in the container and suppressing the plating process, and creates no hazardous substances. The plating composition is highly stable and does not require the addition of non-volatile stabilizers, accelerators, pH regulators or other chemical agents used to enhance plating properties.

In one embodiment, the baths may be used in the formation of thin alloy films. The films are formed by contacting a substrate with the electroless plating bath under the conditions of temperature and pressure described below. The process is autocatalytic, in that no catalyst separate from the aforementioned components is required to advance the alloy deposition on the substrate. Optionally, the contacting comprises complete submersion of the substrate into the bath. In one advantageous feature, more than one substrate may be subjected to contacting simultaneously.

Suitable substrates are catalytically active surfaces such as base and noble metals, alloys, graphite and others, and are most commonly metallic. Suitable materials for the metallic substrate are transition group metals, rare earth metals including lanthanides and actinides, alkali metals, alkaline earth metals, main group metals, alloys comprising at least one of the foregoing metals, and combinations comprising at least one of the foregoing materials. In a specific embodiment, the metallic substrate is copper, iron, molybdenum, indium, cadmium, stainless steel, carbon steel, nickel, chromium, iron- chromium alloys, and nickel-chromium-iron alloys, and the like, as well as combinations comprising at least one of the foregoing materials.

Alternatively, the substrate may be a non-metallic substrate with a surface conductivity effective for plating to occur. The conductivity of the non-metallic substrate may be achieved by coating at least the contacted portion of the substrate with a metal such as a noble metal. Suitable materials for the non-metallic substrate are glass, organic polymers, graphite, metalloid and nonmetal elements, oxides, and the like. In a specific embodiment, the non-metallic substrate may be a polyimide substrate, ceramic, or glass substrate.

Formation of the alloys occurs within a sealed pressure vessel. In one embodiment, the vessel comprises interior facing walls formed of an inert material. Use of an inert material helps to prevent the formation of sludges and other byproducts. The inert material is selected such that it is inert to the bath and may withstand the temperature and pressure of heating. In one embodiment the inert material is a fluorinated polymer. Suitable fluorinated polymers include tetrafluoroethylene (TFE), polytetrafluoroethylene (PTFE), fluoro(ethylene-propylene) (FEP), and the like.

Heating of the sealed pressure vessel provides an energy input effective for carrying out the plating process. The pressure, heating time and temperature affect plating rate and grain size, and may vary depending on the particular bath components and desired plating rate and grain size. Suitable conditions may be determined by one of ordinary skill in the art without undue experimentation using the guidelines provided herein. The heating temperature has a greater effect on plating rate, while the heating time has a greater effect on grain size. The plating rate increases with heating temperature and grain size increases with heating time. In one embodiment, the sealed vessel is heated to about 100 degrees Celsius (° C.) to about 190° C. In another embodiment, the temperature of heating is about 110 to about 180° C. In yet another embodiment, sealed vessel is heated to about 120 to about 160° C. Pressures of about 1 to about 100 (atmospheres) are obtained. Under these conditions, the plating rate may be about 1 to about 10 micrometers per hour. Typically the substrate remains in the plating bath for from about 1 minute to about 24 hours, depending on the required coating thickness, preferably from about 240 minutes to about 12 hours.

After the desired amount of the metal alloy has been coated on the substrate, it is removed from the plating solution. The result is an article having a substantially uniform and virtually alloy plating, having good appearance and properties. Plating can also be done by contacting a substrate surface with a plating bath by any other technique such as spraying, pouring, brushing, and the like, and then subjecting the contacted substrate to the aforementioned conditions.

The grain size of the nanometer-scale thin film alloys produced by the above process average about 1 nanometers (nm) to about 1000 nm, specifically about 50 nm to about 800 nm. Films having an average thickness of about 20 to about 100 micrometers, more specifically about 40 to about 80 micrometers may be produced. The films are conformal, and essentially free of pinholes and other defects. In addition, the coatings are of an even thickness

In another embodiment, wherein no substrate is contacted, bulk alloys are formed under the conditions of temperature and pressure as described above. The grain size of the nanometer-scale bulk alloys average about 1 nm to about 1000 nm, specifically about 50 to about 500 nm.

The thin film and/or bulk alloys are useful in a variety of applications including but not limited to catalysts for laboratory use, catalysts for reforming commercial fuels such as gasoline, diesel fuel, and jet fuel, battery cathodes desiring high surface areas, and surfaces desiring protection from corrosion.

The invention is further illustrated by the following non-limiting example. All references cited herein are incorporated in their entirety.

In these examples, characterization of products was carried out using powder X-ray diffraction (PXRD) for phase identification and scanning electron microscopy (SEM) for grain morphology and size.

### EXAMPLE 1

### Sn—Sb Alloy Plated on a Metal Substrate

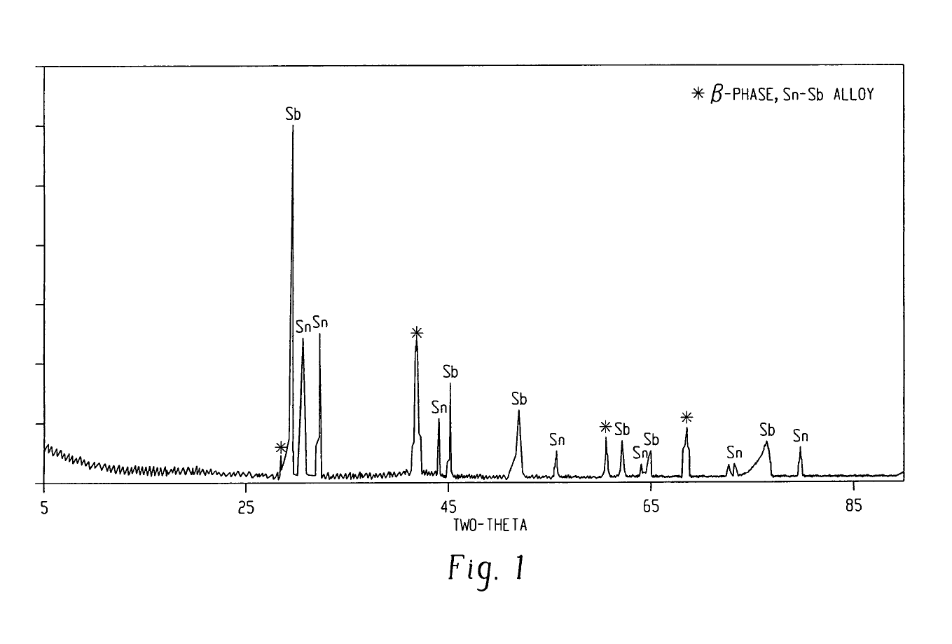

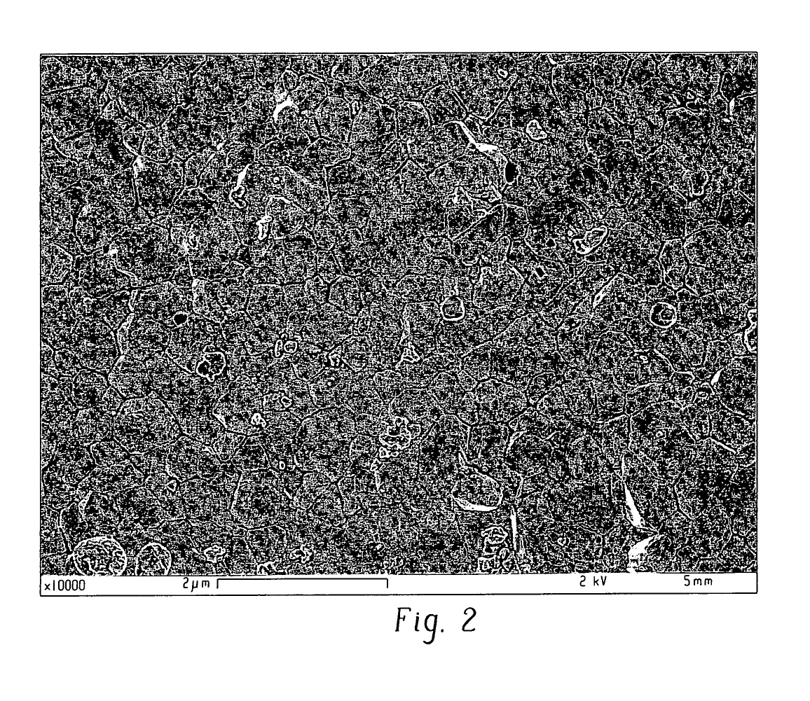

A bath containing 0.60 grams (g) SbCl₃ and 0.50 g SnCl₂ were added to 16 milliliters (ml) ethylenediamine and mixed in a flask. The mixed bath was transferred to a 23 mL Teflon-lined autoclave, followed by addition of 1.20 g KBH₄ and the substrates, which consisted of copper flakes. The autoclave was sealed and heated to 160° C. for 12 hours, after which it was cooled to room temperature and unsealed. The products, which consisted of plated flakes and nanoparticles, were filtered from the organic solution. The organic solution was set aside for possible reuse in another experiment and the filtered products were washed with ethanol and deionized water. As shown in the PXRD pattern of FIG. 1, the product phases were a beta-Sn—Sb alloy along with metallic Sb and Sn. The alloy-plated flakes were then isolated from the nanoparticles and the average particle size for the Sn—Sb alloy was about 450 nm, as evidenced in the electron micrograph shown in FIG. 2.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electroless process comprising:
contacting a substrate with a bath within a sealed pressure vessel; and
heating the sealed pressure vessel for a time and at a temperature under an autogeneous pressure effective for plating a film of an alloy with nanometer-scale grains onto a contacted portion of the substrate;
wherein the bath is formed from one or more salts comprising each constituent element of the alloy, an organic medium, and a reducing agent.

2. The process of claim 1, wherein the contacting is by complete submersion of the substrate into the bath.

3. The process of claim 1, wherein more than one substrate undergoes the contacting.

4. The process of claim 1, wherein the sealed pressure vessel comprises interior facing walls formed of an inert material.

5. The process of claim 4, wherein the inert material is a fluorinated polymer.

6. The process of claim 1, wherein the time for heating the sealed pressure vessel is about 1 minute to about 24 hours.

7. The process of claim 1, wherein the temperature of heating is about 100° C. to about 190° C.

8. The process of claim 1, wherein the one or more salts comprise a chloride anion.

9. The process of claim 1, wherein the organic medium is ethylenediamine.

10. The process of claim 1, wherein the reducing agent is an alkali metal borohydride.

11. An electroless process, comprising:
contacting a substrate in a bath within a sealed pressure vessel, wherein the sealed pressure vessel comprises walls formed of a fluorinated polymer; and
heating the sealed pressure vessel for about 1 minute to about 24 hours, and to a temperature of about 100 to about 190° C. under autogeneous pressure, effective for plating onto the substrate a film of an alloy with average grain size of about 1 to about 1000 nanometers;
wherein the bath is formed from ethylenediamine, an alkali metal borohydride, and one or more salts comprising each constituent element of the alloy, wherein an anion of the salts is chloride.

12. A process, comprising heating a bath in a sealed pressure vessel for a time, and at a temperature under autogeneous pressure, effective for forming a bulk alloy with nanometer-scale grains, wherein the bath is formed from one or more salts comprising each constituent element of the alloy, an organic medium, and a reducing agent.

13. The process of claim 12, wherein the sealed pressure vessel comprises interior facing walls formed of an inert material.

14. The process of claim 12, wherein the time for heating the sealed pressure vessel is about 1 minute to about 24 hours.

15. The process of claim 12, wherein the temperature of heating is about 100° C. to about 190° C.

16. The process of claim 12, wherein the one or more salts comprise a chloride anion, wherein the organic medium is ethylenediamine, or wherein the reducing agent is an alkali metal borohydride.

17. An article made by the process of claim 1.

18. An article made by the process of claim 12.

19. A composition made by the process of claim 1.

20. A composition made by the process of claim 12.
